(19) United States
(12) Patent Application Publication
(10) Pub. No.: US 2025/0324485 A1
(43) Pub. Date: Oct. 16, 2025

(54) ALTERNATING CURRENT HEATING METHOD AND ALTERNATING CURRENT HEATING DEVICE

(71) Applicant: NHK SPRING CO., LTD., Yokohama-shi (JP)

(72) Inventors: Yoshinobu MINO, Yokohama-shi (JP); Keita TAKAHASHI, Yokohama-shi (JP); Satoshi OKABE, Yokohama-shi (JP); Shintaro KUMAI, Yokohama-shi (JP)

(73) Assignee: NHK SPRING CO., LTD., Yokohama-shi (JP)

(21) Appl. No.: 19/250,617

(22) Filed: Jun. 26, 2025

Related U.S. Application Data
(63) Continuation of application No. PCT/JP2023/044884, filed on Dec. 14, 2023.

(30) Foreign Application Priority Data
Dec. 27, 2022 (JP) 2022-210057

(51) Int. Cl. H05B 3/00; H05B 3/12

(52) U.S. Cl. CPC H05B 3/0004; H05B 3/0023; H05B 3/12

(57) ABSTRACT

According to one embodiment, an alternating current heating method includes preparing a conductive workpiece, attaching a first terminal and a second terminal connected to a power source, which is capable of supplying alternating current, to the workpiece, providing a first conductor that is electrically floating at a position that generates proximity effect at time of applying the alternating current to the workpiece, and heating at least part of the workpiece by applying the alternating current to the workpiece through the first terminal and the second terminal.

### CROSS-REFERENCE TO RELATED APPLICATIONS

This application is a Continuation Application of PCT Application No. PCT/JP2023/044884, filed Dec. 14, 2023 and based upon and claiming the benefit of priority from prior Japanese Patent Application No. 2022-210057, filed Dec. 27, 2022, the entire contents of all of which are incorporated herein by reference.

### BACKGROUND OF THE INVENTION

### 1. Field of the Invention

The present invention relates to alternating current heating method and alternating current heating device for heating a workpiece by applying alternating current to the workpiece.

### 2. Description of the Related Art

A method of heating a conductive workpiece by applying alternating current thereto is known.

Specifically, JP S47-35107 B discloses a high-frequency resistance heating device in which a conductor having a substantially same shape as a heating surface of a workpiece (heated object) is provided parallel to the heating surface and the workpiece and the conductor are wired such that current flows through them in opposite directions. This heating device uniformly heats the cross section of the workpiece by utilizing the phenomenon that when current flows through the workpiece and the conductor in opposite directions, the two currents become close to each other.

In addition, JP 5669610 B discloses a direct current heating method that controls the magnetic flux around a plated steel sheet by a magnetic flux derivative to prevent the molten plating from being biased by Lorentz force at the time of heating the plated steel sheet by alternating current.

Controlling heating temperature distribution of a workpiece in alternating current heating has been required. Controlling the heating temperature distribution needs controlling current density distribution at the time of applying current to the workpiece. However, realizing such control with conventional technology involves various issues.

For example, the high-frequency resistance heating device disclosed in JP S47-35107 B results in increasing the resistance at the time of applying current due to the conductor provided around the workpiece. This increases the energy consumption for electric heating. Further, the need to connect the workpiece and the conductor by wiring lines may limit the mobility of the workpiece and the conductor. As in the direct current heating method disclosed in JP 5669610 B, use of the magnetic flux derivative enables controlling the magnetic flux but has difficulty accurately controlling the current density distribution and the heating temperature distribution.

### BRIEF SUMMARY OF THE INVENTION

According to one embodiment, an alternating current heating method includes preparing a conductive workpiece, attaching a first terminal and a second terminal connected to a power source, which is capable of supplying alternating current, to the workpiece, providing a first conductor that is electrically floating at a position that generates proximity effect at time of applying the alternating current to the workpiece, and heating at least part of the workpiece by applying the alternating current to the workpiece through the first terminal and the second terminal.

The alternating current heating method may further include providing a ferromagnetic body near the workpiece. In this case, the workpiece, the first conductor, and the ferromagnetic body may be provided such that the workpiece is located between the first conductor and the ferromagnetic body.

The alternating current heating method may further include providing a second conductor connected to the second terminal and the power source such that the second conductor is electrically insulated from the first conductor. In this case, at time of heating at least part of the workpiece, the alternating current flows through a circuit in which the first terminal, the workpiece, the second terminal, and the second conductor are included in this order.

According to one embodiment, an alternating current heating device includes a power source configured to supply alternating current, a first terminal and a second terminal configured to be connected to the power source and to be attached to a conductive workpiece, a first conductor configured to be electrically floating and to be provided at a position that generates proximity effect at time of applying alternating current to the workpiece. The alternating current heating device heats at least part of the workpiece by applying the alternating current to the workpiece through the first terminal and the second terminal.

For example, the first conductor is in a cylindrical shape that includes a first portion and a second portion, which are divided in a circumferential direction. In this case, the first portion may include a first flange portion provided at an end in the circumferential direction, the second portion may include a second flange portion provided at an end portion in the circumferential direction, and the first portion and the second portion may become electrically continuous by bringing the first flange portion and the second flange portion in contact.

As another example, the first portion may have a first tapered surface provided at an end portion in the circumferential direction and inclined with respect to a radial direction of the first conductor, the second portion may have a second tapered surface provided at an end portion in the circumferential direction and inclined with respect to the radial direction, and the first portion and the second portion may become electrically continuous by bringing the first tapered surface and the second tapered surface in contact.

As yet another example, the first portion and the second portion may be connected to each other by a conductive material having elasticity or flexibility.

As yet another example, one of the first portion and the second portion may have a recess provided at an end portion in the circumferential direction, and the other of the first portion and the second portion may have a protrusion insertable into the recess.

As yet another example, the first portion and the second portion may be connected to each other via conductive liquid.

The first conductor is preferably formed of a metal material with excellent electrical conductivity, such as copper, a copper alloy, aluminum, or an aluminum alloy.

The alternating current heating device may further include a ferromagnetic body configured to be provided near the workpiece. The alternating current heating device may further include a second conductor configured to be connected to the second terminal and the power source and to be electrically insulated from the first conductor.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a schematic configuration of an alternating current heating device according to the first embodiment.

FIG. 2 is a side view of a coil spring, which is an example of a workpiece, a conductor, and a ferromagnetic body.

FIG. 3 is a schematic side view showing another configuration applicable to the coil spring, the conductor, and the ferromagnetic body.

FIG. 4 is a schematic diagram to illustrate the proximity effect.

FIG. 5 is a schematic perspective view showing current density distribution (heating temperature distribution) of a coil spring when a conductor is not provided.

FIG. 6 is a schematic perspective view showing current density distribution (heating temperature distribution) of a coil spring when a conductor is provided.

FIG. 7 is a schematic perspective view showing current density distribution (heating temperature distribution) of a coil spring when a conductor and a ferromagnetic body are not provided.

FIG. 8 is a schematic perspective view showing current density distribution (heating temperature distribution) of a coil spring when a ferromagnetic body is provided.

FIG. 9 is (a) a front view and (b) a side view each showing an example of a heating device comprising divided conductors.

FIG. 10 is (a) a front view and (b) a side view each showing another example of the heating device comprising divided conductors.

FIG. 11 is (a) a front view and (b) a side view each showing still another example of the heating device comprising divided conductors.

FIG. 12 is (a) a front view and (b) a side view each showing still another example of the heating device comprising divided conductors.

FIG. 13 shows another example of a configuration applicable to a connection portion for the divided conductors.

FIG. 14 shows still another example of the configuration applicable to the connection portion for the divided conductors.

FIG. 15 shows still another example of the configuration applicable to the connection portion for the divided conductors.

FIG. 16 is a schematic cross-sectional view showing a modified example of a shape applicable to the conductor.

FIG. 17 is a schematic cross-sectional view showing another modified example of the shape applicable to the conductor.

FIG. 18 is a schematic cross-sectional view showing still another modified example of the shape applicable to the conductor.

FIG. 19 is a schematic cross-sectional view showing still another modified example of the shape applicable to the conductor.

FIG. 20 is a diagram showing a schematic configuration of a heating device according to the second embodiment.

FIG. 21 is a flowchart showing an example of a coil spring manufacturing method.

FIG. 22 is a flowchart showing another example of the coil spring manufacturing method.

FIG. 23 is a flowchart showing still another example of the coil spring manufacturing method.

### DETAILED DESCRIPTION OF THE INVENTION

Some embodiments will be described hereinafter with reference to the accompanying drawings. Each embodiment may show a coil spring as a workpiece to be heat-treated (heated object). However, alternating current heating devices disclosed in each embodiment and alternating current heating methods using these devices are applicable to all heat-treated products to be subjected to heat treatment.

For example, workpieces other than a coil spring include plate springs, stabilizers for vehicles, various bend products, rolled materials, composite materials, and the like. That is, the workpiece material may be metal other than spring steel. Material property of the workpiece is not limited to wire materials such as wires forming coil springs, but may also be plate materials or a deformed material such as tube materials.

The types of heat treatment for the workpiece are not particularly limited. Examples of the heat treatment are assumed to include quenching, tempering, annealing, and surface softening treatment on the workpiece.

### First Embodiment

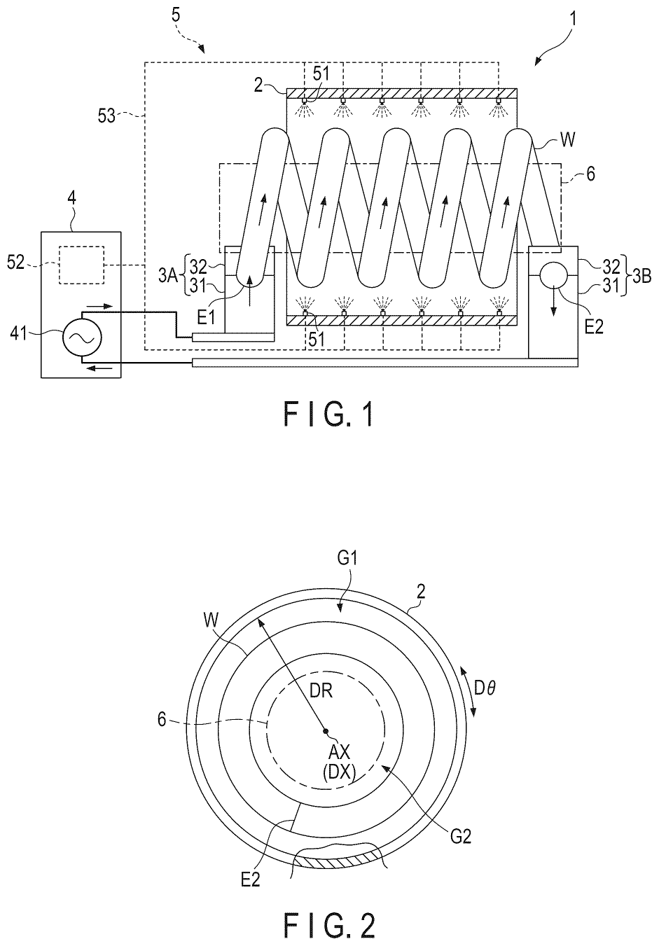

FIG. 1 is a diagram showing a schematic configuration of an alternating current heating device 1 (hereinafter referred to as a heating device 1) according to the first embodiment. The heating device 1 comprises a conductor 2 (the first conductor), a first terminal 3A, a second terminal 3B, and a control device 4.

For example, the conductor 2 is in a cylindrical shape and is formed of a metal material with excellent electrical conductivity, such as copper, a copper alloy, aluminum, an aluminum alloy, or a composite material containing one or more of these. The control device 4 comprises a power source 41 for supplying alternating current. The first terminal 3A and the second terminal 3B are connected to the power source 41 via wiring lines. The frequency of the alternating current supplied by the power source 41 is not limited. For example, a high frequency of 1 kHz or higher can be used.

In the example of FIG. 1, each of the first terminal 3A and the second terminal 3B is divided into a lower portion 31 and an upper portion 32. The first terminal 3A and the second terminal 3B can be attached to the workpiece by these lower portion 31 and upper portion 32 clamping part of the workpiece. However, the configuration for attaching the first terminal 3A and the second terminal 3B to the workpiece is not limited to this example.

The heating device 1 performs heat treatment in the alternating current heating method (hereinafter referred to as a heating method) according to the present embodiment. In the heat treatment performed by the heating device 1 according to the present embodiment, a coil spring W, an example of the workpiece, is prepared first. The coil spring W is formed by coiling wires such as spring steel into a spiral shape by a coiling machine and is conductive.

Further, the first terminal 3A and the second terminal 3B are attached to the coil spring W, and the coil spring W is provided inside the conductor 2. The implementation order of the process of attaching the first terminal 3A and the second terminal 3B to the coil spring W and the process of providing the coil spring W inside the conductor 2 is not particularly limited.

In the example of FIG. 1, part of the coil spring W near end portions E1 and E2 (at least part of an end turn) protrudes from the both end portions of the conductor 2. The configuration is not limited to this example. The entire coil spring W may be surrounded by the conductor 2.

For example, the first terminal 3A and the second terminal 3B are attached near the end portions E1 and E2 of the coil spring W. In the example of FIG. 1, the lower portion 31 and the upper portion 32 of the first terminal 3A clamp the part near the end portion E1 of the coil spring W. The lower portion 31 and the upper portion 32 of the second terminal 3B clamp the portion near the end portion E2 of the coil spring W.

Attaching the first terminal 3A and the second terminal 3B to the coil spring W form a circuit in which these elements and the power source 41 are connected in series. The control unit 4 starts applying current to the coil spring W in response to the operation of a switch by an operator or the receipt of a control signal from the outside. FIG. 1 shows an example of the flowing direction of current by the solid arrows. This direction periodically changes according to the frequency of the power source 41.

This current application heats at least part of the coil spring W. At this time, the proximity effect described later occurs between the conductor 2 and the coil spring W. The conductor 2 is provided at the position where this proximity effect occurs.

The frequency, amplitude, and time of applying of alternating current can be appropriately determined according to the properties of the coil spring W (for example, wire diameter, cross-sectional shape, coil diameter, coil length, pitch, number of turns, material property), the area to be heated, and the target temperature for heating. When the timing to stop heating comes, the control device 4 stops current application from the power source 41.

Then, the coil spring W is cooled. This cooling may be natural cooling. If rapid cooling is required, cooling may be performed by spraying a fluid such as water or air to the coil spring W. In the example of FIG. 1, the heating device 1 comprises a cooling mechanism 5 to perform spraying such fluid.

For example, the cooling mechanism 5 comprises multiple nozzles 51 provided on the inner surface of the conductor 2, a fluid supply source 52 in the control device 4, and a piping 53 connecting each nozzle 51 to the fluid supply source 52. For example, the fluid supply source 52 supplies fluid to each of the nozzles 51 through the piping 53 under the control of the control device 4. At this time, each of the nozzles 51 sprays fluid toward the coil spring W. The nozzles 51 may not be provided on the conductor 2, but may be provided on a member different from the conductor 2.

The heating device 1 may further comprise a ferromagnetic body 6 placeable near the coil spring W. For example, the ferromagnetic body 6 is formed of ferrite, but is not limited to this example. In the example of FIG. 1, the ferromagnetic body 6 is inserted inside the coil spring W.

FIG. 2 is a schematic side view of the coil spring W, the conductor 2, and the ferromagnetic body 6 that are assembled in the manner shown in FIG. 1. FIG. 2 shows the cross-sectional configuration of part of the conductor 2. The following description defines an axial direction DX along an axis AX of the coil spring W, a radial direction DR passing through and perpendicular to the axis AX, and a circumferential direction Dθ around the axis AX as shown in FIG. 2.

The conductor 2 is in a cylindrical shape, for example, around the axis AX. In the example of FIG. 2, the conductor 2 has a single layer structure of a conductive metal material. The conductor 2 is electrically floating and insulated from other conductive elements such as the coil spring W. The conductor 2 is supported, for example, by an insulating member (not shown).

A gap G1 is formed between the conductor 2 and the coil spring W. That is, the inner surface of the conductor 2 faces the outer-diameter-side surface of the coil spring W via the gap G1. In the example of FIG. 2, the size of the gap G1 is constant at any position in the circumferential direction Dθ. The configuration is not limited to this example.

The ferromagnetic body 6 has a columnar shape, for example, around the axis AX. The ferromagnetic body 6 may have other shapes such as a cylindrical shape around the axis AX. The ferromagnetic body 6 is electrically floating as well and insulated from other conductive elements such as the conductor 2 and the coil spring W. The ferromagnetic body 6 is supported, for example, by an insulating member (not shown).

A gap G2 is formed between the ferromagnetic body 6 and the coil spring W. That is, the outer surface of the ferromagnetic body 6 faces the inner-diameter-side surface of the coil spring W via the gap G2. In the example of FIG. 2, the size of the gap G2 is constant at any position in the circumferential direction Dθ. The configuration is not limited to this example.

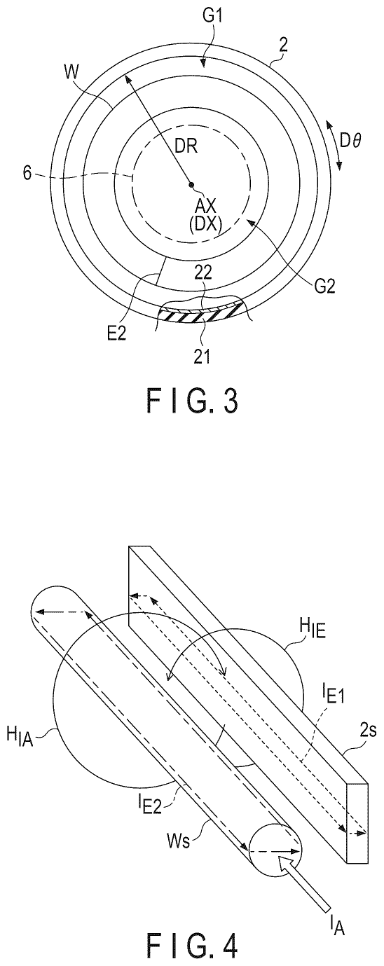

FIG. 3 is a schematic side view showing another configuration applicable to the coil spring W, the conductor 2, and the ferromagnetic body 6. This figure shows the cross-sectional configuration of part of the conductor 2 as well. In the example in FIG. 3, the conductor 2 comprises an insulating portion 21 and a conductive portion 22.

The insulating portion 21 is formed into a cylindrical shape, for example, by insulating materials such as plastic. The conductive portion 22 is formed of a conductive material, such as copper, a copper alloy, aluminum, an aluminum alloy, or a composite material containing one or more of these, and covers the inner surface of the insulating portion 21. The conductive portion 22 faces the outer-diameter-side surface of the coil spring W through the gap G1.

The conductive portion 22 is a thin film formed or coated, for example, on the inner surface of the insulating portion 21. The conductive portion 22 may be a tape-like member attached to the inner surface of the insulating portion 21 via an adhesive layer. Further, the conductive portion 22 may be a cylindrical member molded separately from the insulating portion 21 and fitted inside the insulating portion 21.

For example, the conductive portion 22 covers the entire inner surface of the insulating portion 21. As another example, the conductive portion 22 may cover part of the inner surface of the insulating portion 21.

The following describes the function of the conductor 2. What is called the proximity effect occurs when electric current flows through a workpiece such as the coil spring W and an electrically floating conductor is provided in its vicinity. The present embodiment utilizes this proximity effect to control the current density distribution (heating temperature distribution) of the coil spring W.

FIG. 4 is a schematic diagram to illustrate the proximity effect, showing a bar-shaped workpiece Ws and a conductor 2s provided in its vicinity. When a current I_{A} from the power source flows to the workpiece Ws, a magnetic field H_{IA} is generated around the workpiece Ws (Ampere's law).

In the conductor 2s, an eddy current I_{E1} is generated due to this magnetic field H_{IA} (Lenz's law). Furthermore, a magnetic field H_{IE} is generated around the conductor 2s due to the eddy current I_{E1}. When this magnetic field H_{IE} acts on the workpiece Ws, an eddy current I_{E2} is generated in the workpiece Ws.

The directions of flow of the current I_{A}, the eddy current I_{E1}, and the eddy current I_{E2} are indicated by the arrows in the figure. In other words, in the workpiece Ws, the current I_{A} and the eddy current I_{E2} flow in directions opposite to each other near the side surface that is far from the conductor 2s. In contrast, the current I_{A} and the eddy current I_{E2} flow in the same direction near the side surface that is close to the conductor 2s. Thus, the current density of the workpiece Ws is higher near the side surface that is close to the conductor 2s.

Utilizing this proximity effect enables controlling the current density distribution and the heating density distribution of the workpiece Ws. For example, providing the conductor 2s to face part of the outer surface of the workpiece Ws as shown in FIG. 4, can yield the current density distribution and the heating density distribution that vary according to a circumferential position on the surface and the inside of the workpiece Ws. These distributions can be appropriately adjusted, for example, by the distance between the conductor 2s and the workpiece Ws.

Further, providing the conductor 2s to face only part of the workpiece Ws in the longitudinal direction of the workpiece Ws can yield the current density distribution and the heating density distribution that vary according to the longitudinal position on the surface and the inside of the workpiece Ws.

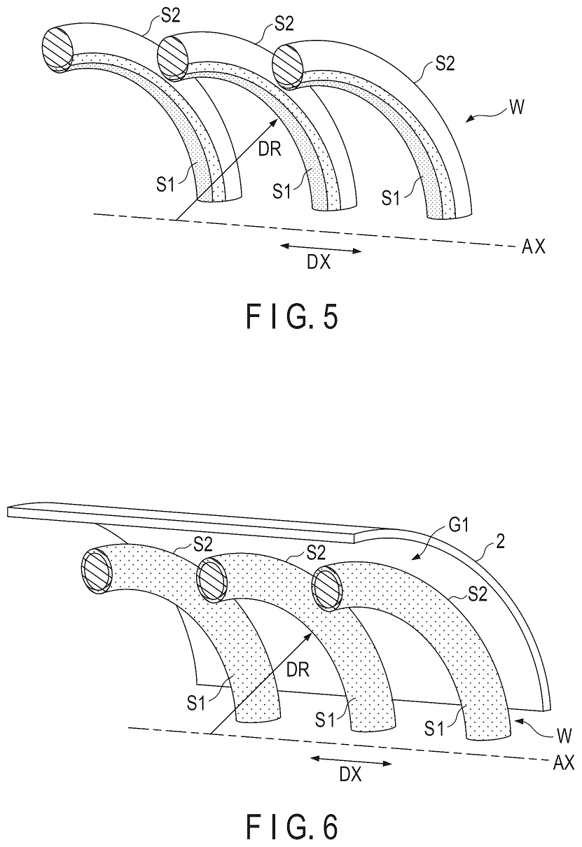

The following describes the electric heating and the proximity effect in cases where the workpiece is the coil spring W with reference to FIG. 5 and FIG. 6. FIG. 5 is a schematic perspective view showing current density distribution (heating temperature distribution) of the coil spring W when the conductor 2 is not provided. FIG. 6 is a schematic perspective view showing current density distribution (heating temperature distribution) of the coil spring W when the conductor 2 is provided. These figures partially show the coil spring W and the conductor 2. In addition, the area with the high current density (with the high heating temperature) in the coil spring W is indicated by a dot pattern.

When alternating current flows through a work such as the coil spring W, the skin effect occurs and thus increases the current density of its surface. Furthermore, in a workpiece with a non-linear bent portion, such as a coil spring W, the current density near the inner surface of the bending is likely to increase due to its short current path passing through the inner surface of the bending.

Specifically, in the example of FIG. 5, the current density near an inner-diameter-side surface S1 of the coil spring W (part of the surface of the coil spring W that faces the axis AX) is higher than that near an outer-diameter-side surface S2. Thus, the area near the inner-diameter-side surface S1 is preferentially heated.

In contrast, when the conductor 2 is provided around the coil spring W, the proximity effect attracts the current biased toward the inner-diameter-side surface S1 to the outer-diameter-side surface. This makes the current density distribution and the heating temperature distribution uniformed in the circumferential direction of the wire of the coil spring W, as shown in FIG. 6, for example. As another example, the current density near the outer-diameter-side surface S2 may be higher than the current density near the inner-diameter-side surface S1 by adjusting the gap G1 between the conductor 2 and the coil spring W and the like. Further, the current density distribution and the heating temperature distribution achieved by the heating device 1 can be appropriately adjusted according to the properties required for the workpiece.

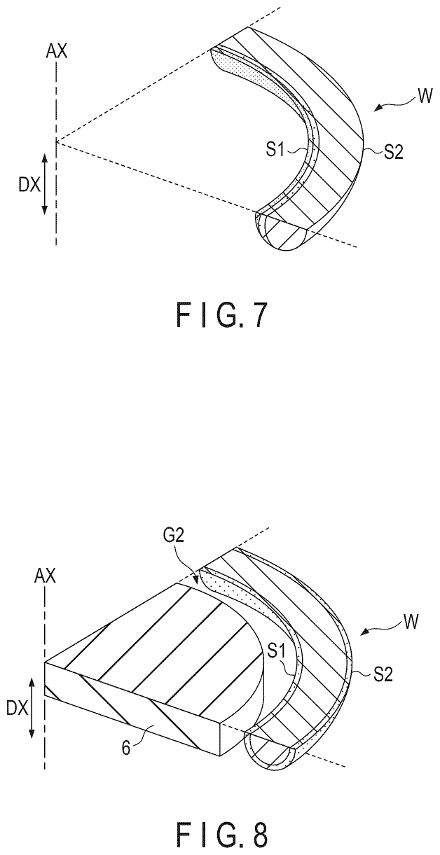

The current density distribution and the heating temperature distribution can be controlled by the ferromagnetic body 6 as well. FIG. 7 is a schematic perspective view showing current density distribution (heating temperature distribution) of the coil spring W when the conductor 2 and the ferromagnetic body 6 are not provided. FIG. 8 is a schematic perspective view showing the current density distribution (heating temperature distribution) of the coil spring W when the ferromagnetic body 6 is provided. These figures partially show the coil spring W and the conductor 2. Similarly to FIG. 5 and FIG. 6, the area with the high current density (with the high heating temperature) in the coil spring W is indicated by a dot pattern.

As described above, when the conductor 2 and the ferromagnetic body 6 are not provided, the current density near the inner-diameter-side surface S1 is higher than that near the outer-diameter-side surface S2, as shown in FIG. 7. The ferromagnetic body 6 has the function of influencing the magnetic flux produced at the time of current application and spreading the biased current density, like one shown in FIG. 7, to the outer diameter side of the coil spring W.

Thus, similarly to cases where the conductor 2 is provided, the current density distribution and the heating temperature distribution can be controlled by providing the ferromagnetic body 6 as well, as shown in FIG. 8. In the example of FIG. 8, the current density distribution and the heating temperature distribution are uniformed in the circumferential direction of the wire of the coil spring W. The configuration is not limited to this example.

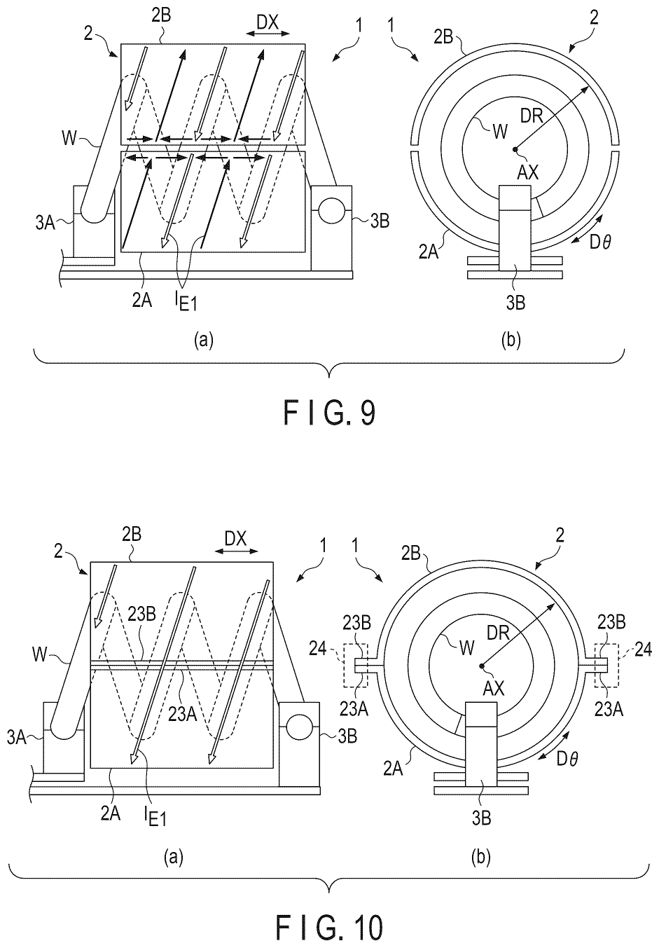

FIG. 1 to FIG. 3 show cases where the conductor 2 is a seamless cylindrical member as examples. The configuration is not limited to this example. The conductor 2 may be divided into multiple parts. FIG. 9 is (a) a front view and (b) a side view each showing an example of the heating device 1 comprising the divided conductor 2. In the example of this figure, the conductor 2 has a first portion 2A and a second portion 2B that are divided in the circumferential direction Dθ.

This configuration facilitates the work of providing the conductor 2 around the coil spring W. For example, even after attaching the first terminal 3A and the second terminal 3B to the coil spring W, the conductor 2 can be provided without being disturbed by these terminals 3A and 3B and wiring lines connecting these terminals 3A and 3B to the power source 41.

On the other hand, when the first portion 2A and the second portion 2B are spaced apart from each other as shown in FIG. 9, the eddy current I_{E1} generated in the conductor 2 at the time of current application to the coil spring W turns back at the ends of the first portion 2A and the second portion 2B. This makes proximity effect on the coil spring W uneven as well, causing undesired unevennesses in the current density distribution. Even when the end portions of the first portion 2A and the second portion 2B contact each other, the current density distribution of the coil spring W may be disturbed near the boundaries between the first and second portions 2A and 2B.

FIG. 10 is (a) a front view and (b) a side view each showing another example of the heating device 1 comprising the divided conductor 2. In the example of this figure as well, the conductor 2 is divided into the first portion 2A and the second portion 2B. Furthermore, the first portion 2A includes a first flange portion 23A and the second portion 2B has a second flange portion 23B.

The first flange portion 23A protrudes in the radial direction DR from both end portions of the first portion 2A in the circumferential direction Dθ. The second flange portion 23B protrudes in the radial direction DR from both end portions of the second portion 2B in the circumferential direction Dθ. These flange portions 23A and 23B extend parallel to the axial direction DX.

The flange portions 23A and 23B may be connected to each other by a plurality of coupling members 24. For example, the coupling member 24 presses the flange portions 23A and 23B together. The coupling member 24 can be a combination of bolts and nuts, or a clip-like member that clips the flange portions 23A and 23B together.

Pressing the flange portions 23A and 23B together achieves stable electrical continuity between the first portion 2A and the second portion 2B, reducing the influence of the boundaries between these portions on the eddy current I_{E1}. Thus, the eddy current I_{E1} flows through the conductor 2 approximately seamlessly without turning back at the boundaries. This makes the proximity effect on the coil spring W uniformed as well, achieving a suitable current density distribution.

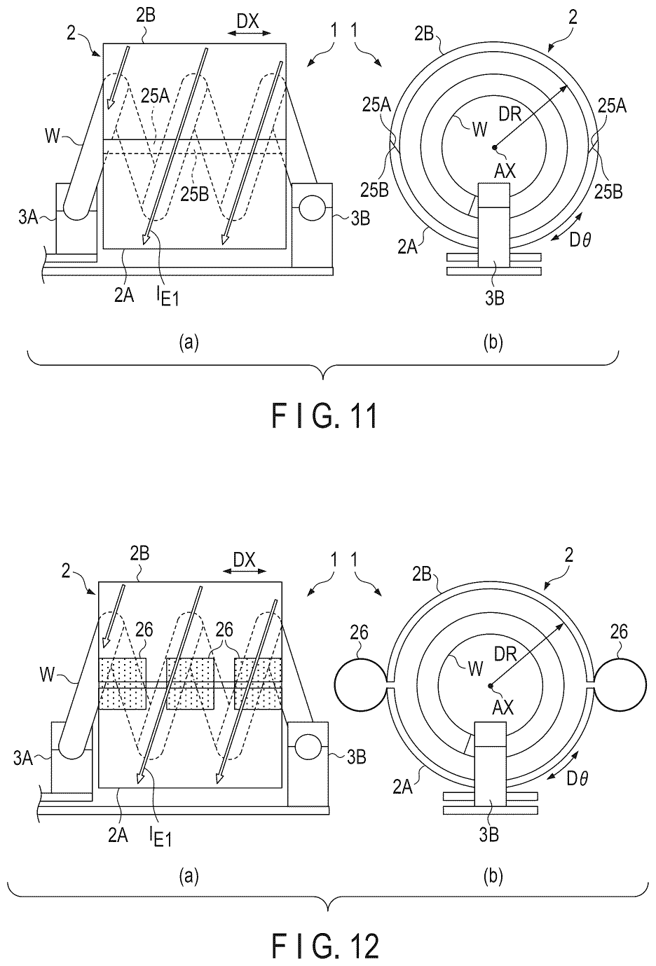

FIG. 11 is (a) a front view and (b) a side view each showing still another example of the heating device 1 comprising the divided conductor 2. In the example of this figure as well, the conductor 2 is divided into the first portion 2A and the second portion 2B. Further, the first portion 2A has a first tapered surface 25A, and the second portion 2B has a second tapered surface 25B.

The first tapered surface 25A is provided on both end portions in the circumference direction Dθ of the first portion 2A and is inclined with respect to the radial direction DR. The second tapered surface 25B is provided on both end portions in the circumference direction Dθ of the second portion 2B and is inclined with respect to the radial direction DR.

The first portion 2A and the second portion 2B are provided such that the tapered surfaces 25A and 25B are in surface contact. A coupling member, which presses the first portion 2A and the second portion 2B such that the tapered surfaces 25A and 25B are pressed together, may be further provided.

The tapered surfaces 25A and 25B provided in the example of FIG. 11 increases the contact area at both end portions of the first portion 2A and second portion 2B. This achieves stable electrical continuity between the first portion 2A and the second portion 2B and thus achieves the same effect as in the example in FIG. 10.

FIG. 12 is (a) a front view and (b) a side view each showing still another example of the heating device 1 comprising the divided conductor 2. In the example of this figure as well, the conductor 2 is divided into the first portion 2A and the second portion 2B. Further, the first portion 2A and the second portion 2B are connected to each other by a plurality of conductive materials 26.

For example, the conductive material 26 is formed into a sheet shape. One end of the conductive material 26 is connected to an end portion in the circumference direction Dθ of the first portion 2A. The other end is connected to an end portion in the circumferential direction Dθ of the second portion 2B. For example as shown in FIG. 12(b), the conductive material 26 is flexible enough to warp when the end portions of the first portion 2A and second portion 2B are brought into proximity to each other. FIG. 12 shows the state where the end portions of the first portion 2A and second portion 2B are spaced apart from each other. At the time of current application, the first portion 2A and the second portion 2B are pressed together such that these end portions contact each other. The conductive material 26 is not limited to flexible sheet-shaped portions. As another example, the conductive material 26 may be a plate spring having elasticity and the like.

By providing the conductive material 26, even when the end portions of the first portion 2A and the second portion 2B are spaced apart from each other, as shown in FIG. 12(b), for example, the electrical continuity between the first portion 2A and the second portion 2B can be ensured. This achieves the same effects as the examples of FIG. 10 and FIG. 11.

As shown in FIG. 12(a), each conductive material 26 may be located where the boundaries between the first portion 2A and the second portion 2B face the outer-diameter-side surface of the coil spring W. This prevents disturbances in the path of the eddy current I_{E1} formed along the coil spring W.

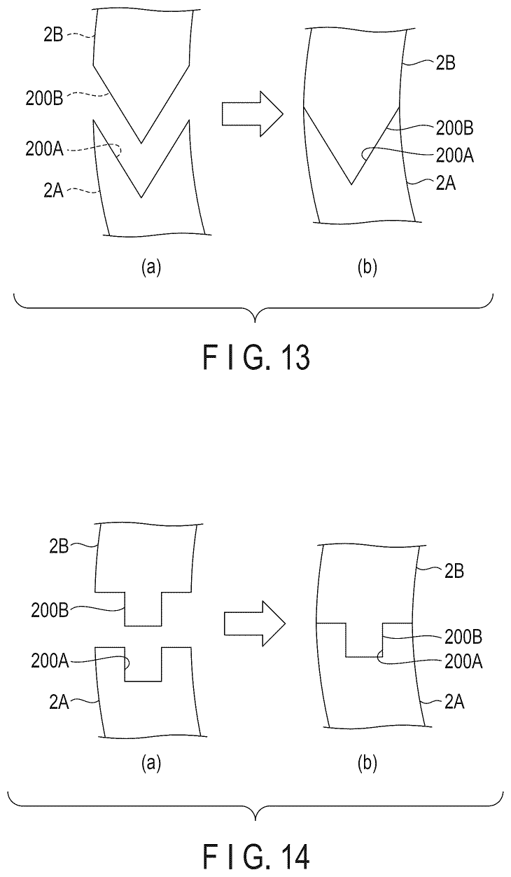

FIG. 13 to FIG. 15 show other examples applicable to the connection portion for the first portion 2A and the second portion 2B. In these examples, a recess 200A is provided at the end portion of the first portion 2A, and a protrusion 200B is provided at the end portion of the second portion 2B.

The recess 200A and the protrusion 200B have the shapes that fit into each other. More specifically, each of the recess 200A and the protrusion 200B in the example of FIG. 13(a) has a V-shaped cross-sectional shape. Each of the recess 200A and the protrusion 200B in the example of FIG. 14(a) has a rectangular cross-sectional shape.

At time of connecting the first portion 2A and the second portion 2B, the protrusion 200B is inserted into the recess 200A as shown in FIG. 13(b) and FIG. 14(b). This suppresses misalignment of the first portion 2A and the second portion 2B and increases the contact area between them, compared to cases where the end portions of the first portion 2A and the second portion 2B are flat. Thus, this achieves stable electrical continuity between the first portion 2A and the second portion 2B.

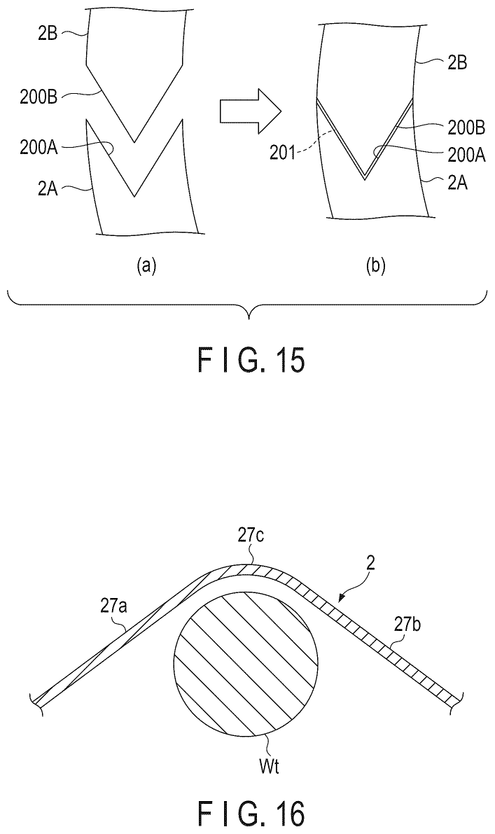

The shapes of the recess 200A and the protrusion 200B in the example of FIG. 15(a) are the same as those in the example of FIG. 13. However, in the example of FIG. 15(b), a conductive liquid 201 is provided between the connecting surfaces of the first portion 2A and the second portion 2B. For example, conductive paste, conductive grease, or conductive adhesive material can be used as the conductive liquid 201. The conductive liquid 201 may be applied to the recess 200A before being connected, or the protrusion 200B, or to both of the recess 200A and the protrusion 200B.

FIG. 13 to FIG. 15 show the configuration where a recess is provided in the first portion 2A located on the lower side, and a protrusion is provided in the second portion 2B located on the upper side. The configuration is not limited to this example. The protrusion may be provided on the first portion 2A, and the recess may be provided on the second portion 2B. The conductive liquid 201 may be provided at the end portions of the first portion 2A and the second portion 2B in the configurations shown in FIG. 10, FIG. 11, FIG. 12, and FIG. 14.

FIG. 9 to FIG. 15 show the examples where the conductor 2 is divided into two portions in the circumferential direction Dθ. The configuration is not limited to this example. The conductor 2 may be divided into three or more portions in the circumferential direction Dθ. The conductor 2 may be divided into a plurality of portions in the axial direction DX. In these cases, the same configurations as those in FIG. 10 to FIG. 15 may be adopted for connecting the divided plurality of portions.

FIG. 1, FIG. 2, and the like show the conductor 2 in a regular cylindrical shape as examples. However, the conductor 2 may have various shapes depending on the workpieces. FIG. 16 to FIG. 19 are schematic cross-sectional views showing modified examples of shapes applicable to the conductor 2. These figures show the cross section of part of a workpiece Wt and the cross section of the conductor 2 near the workpiece Wt. For example, when the workpiece Wt is the coil spring W, the cross section of the workpiece Wt in each figures corresponds to the transverse section of the wire of the coil spring W.

In the examples of FIG. 16 to FIG. 19, the conductor 2 surrounds the workpiece Wt in three directions. More specifically, in the example of FIG. 16, the conductor 2 has a pair of flat portions 27a and 27b and a bent portion 27c coupling these flat portions 27a and 27b. The cross-sectional shape of the bent portion 27c is an arc shape smoothly bent along the outer circumferential surface of the workpiece Wt.

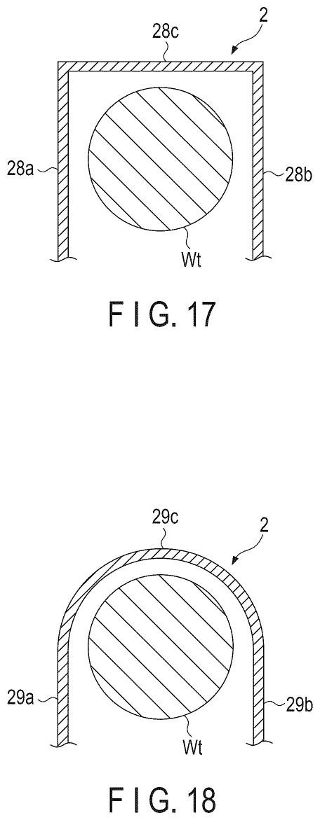

In the example of FIG. 17, the conductor 2 has a pair of flat portions 28a and 28b that are parallel to each other and a flat portion 28c coupling these flat portions 28a and 28b. The flat portion 28c is perpendicular to the flat portions 28a and 28b.

In the example of FIG. 18, the conductor 2 has a pair of flat portions 29a and 29b that are parallel to each other and a flat portion 29c coupling these flat portions 29a and 29b. The cross-sectional shape of the bent portion 29c is an arc shape smoothly bent along the outer circumferential surface of the workpiece Wt.

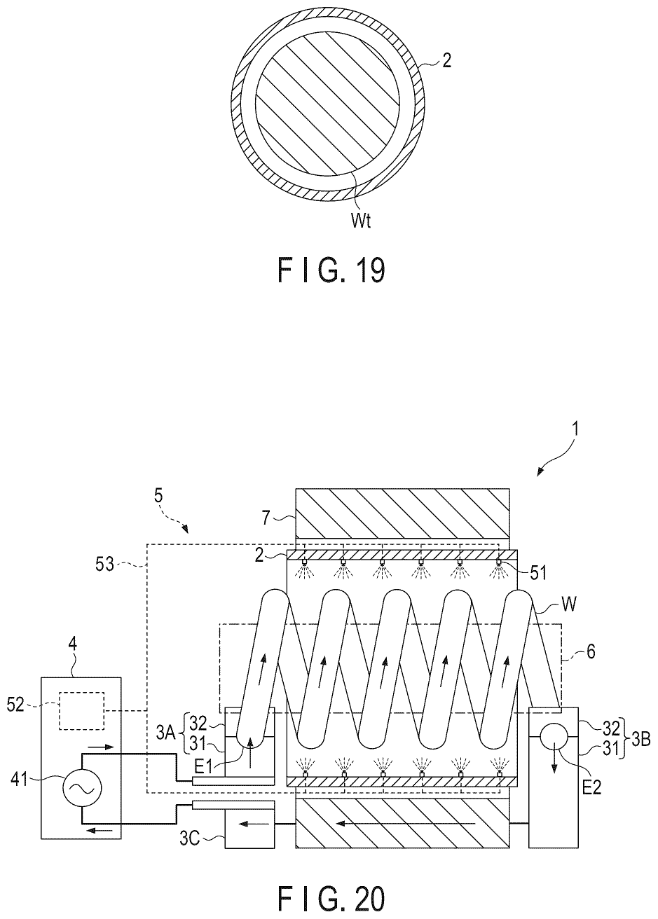

In the example of FIG. 19, the conductor 2 covers the entire circumference of the workpiece Wt. The cross-sectional shape of the conductor 2 is, for example, a regular circle, but may be other shapes, such as an oval.

For example, when the workpiece Wt is the coil spring W, the conductor 2 may have the structure in which the shapes shown in any of FIG. 16 to FIG. 18 are continuously provided. Further, the conductor 2 may be formed by appropriately combining the shapes shown in FIG. 16 to FIG. 19. Further, various shapes are applicable to the conductor 2.

The above heating device 1 and the heating method according to the present embodiment controls the current density distribution and the heating temperature distribution in the workpiece by the proximity effect formed between the conductor 2 that is electrically floating and the workpiece. This enables controlling distribution of properties such as hardness, stress, and structures in each portion of the workpiece. Use of the ferromagnetic body 6 in addition to the conductor 2 further improves the control accuracy of the current density distribution, the heating temperature distribution, and the distribution of properties obtained by these.

More specifically, the distribution of properties in the depth direction of the workpiece from the surface, the circumferential direction of the workpiece, the length direction of the workpiece can be controlled by controlling control factors such as the distance between the conductor 2 and the workpiece, the shape and material property of the conductor 2, the position which the conductor 2 faces on the surface of the workpiece, the distance between the ferromagnetic body 6 and the workpiece, the shape and material property of the ferromagnetic body 6, the position which the ferromagnetic material body 6 faces on the surface of the workpiece, the time of current application to the workpiece (heating time), the frequency of the power source 41, and the like.

The present embodiment can various favorable effects in addition to the above-described effects.

### Second Embodiment

The following describes the second embodiment. The same structural elements as the first embodiment are denoted by the same reference numbers. Thus, overlapping descriptions are omitted.

FIG. 20 is a diagram showing a schematic configuration of a heating device 1 according to the second embodiment. Similarly to the first embodiment, the heating device 1 comprises a conductor 2 (the first conductor), a first terminal 3A, a second terminal 3B, and a control device 4. Similarly to the example of FIG. 1, the heating device 1 may comprise a cooling mechanism 5 and a ferromagnetic body 6.

Further, the heating device 1 shown in FIG. 20 comprises a conductor 7 (the second conductor) and a third terminal 3C. The conductor 7 has a shape that can be provided to surround the conductor 2 and a coil spring W. For example, the conductor 7 is a cylindrical shape whose both end portions are open, but may be in other shapes.

For example, the conductor 7 is formed of a metal material with excellent electrical conductivity, such as copper, a copper alloy, aluminum, an aluminum alloy, or a composite material containing one or more of these. The conductor 7 is electrically insulated from the conductor 2. These conductors 2 and 7 are simply be spaced apart from each other. Alternatively, an insulating layer may be provided between these conductors 2 and 7.

The second terminal 3B is connected to the conductor 7 via wiring lines. The conductor 7 is connected to the third terminal 3C via wiring lines. Further, the third terminal 3C is connected to a power source 41 via wiring lines.

Attaching the first terminal 3A and the second terminal 3B to the coil spring W forms a circuit in which the power source 41, the first terminal 3A, the coil spring W, the second terminal 3B, the conductor 7, and the third terminal 3C are connected in this order. FIG. 20 shows an example of current flowing in the circuit by the solid arrows. The flowing direction of this current periodically switches according to the frequency of the power source 41.

Similarly to the first embodiment, the configuration of the heating device 1 of the present embodiment can control the current density distribution and the heating temperature distribution by the conductor 2, the ferromagnetic body 6, and the like. Each of the configurations disclosed in the first embodiment is applicable to the heating device 1 according to the second embodiment as well.

Like the conductor 2 shown in FIG. 9 to FIG. 15, the conductor 7 may be divided into a plurality of portions. In this case, the work of installing the conductor 7 around the coil spring W and the conductor 2 is facilitated. The arrangement configuration of the conductor 2, the conductor 7, the coil spring W, and the ferromagnetic body 6 is not limited to the arrangement configuration shown in FIG. 20. For example, the conductor 7 may be provided inside the coil spring W. In this case, the conductor 2 may be provided between the coil spring W and the conductor 7, and the ferromagnetic body 6 may be provided outside the coil spring W.

### Example of Application to the Coil Spring Manufacturing Method

The following discloses, as an example, a coil spring manufacturing method adopting the heating method using the heating device 1 disclosed in the first and second embodiments.

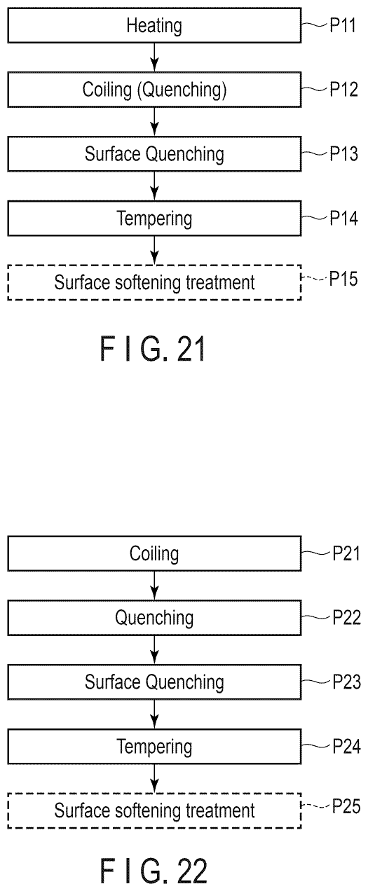

FIG. 21 is a flowchart showing an example of a coil spring manufacturing method. This example corresponds to what is called hot forming. In this example, wires such as spring steel is heated first (process P11). Further, the wire, which has become hot by heating in the process P11 is formed into a helical shape by a coiling machine (process P12). The wire is quenched in these processes P11 and P12. If necessary, surface quenching is performed to reduce the hardness of the interior near the surface of the wire after the process P12 (process P13). Then, tempering is performed on the wire (process P14).

After the process P13, a surface softening treatment may be performed to soften the surface of the wire (process P15). The surface softening treatment may be performed on the entire coil spring or part of the coil spring in the length direction, such as the end turn portion.

FIG. 22 is a flowchart showing another example of the coil spring manufacturing method. In this example, first, the wire is formed into a helical shape by the coiling machine (process P21). After the process P21, quenching is performed on the wire (process P22). Thereafter, if necessary, the same surface quenching as that in the process P13 is performed on the wire (process P23). Further, the same tempering as that in the process P14 is performed on the wire (process P24). After the process P23, the same surface softening treatment as that in the process P15 may be performed (process P25).

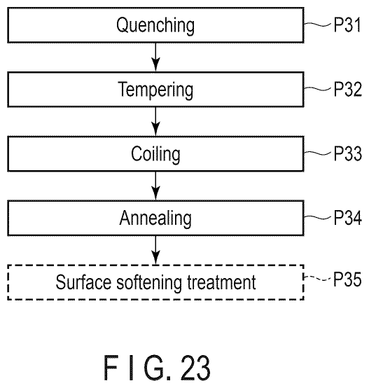

FIG. 23 is a flowchart showing still another example of the coil spring manufacturing method. This example corresponds to what is called cold forming. In this example, the wire is quenched first (process P31). After quenching, the wire is tempered (process P32).

After the process P32, the wire is formed into a helical shape by the coiling machine (process P33). Further, the wire is annealed by being heated to a prescribed temperature (process P34). After the process P33, the same surface softening treatment as that in the process P15 may be performed (process P35).

The heating method using the heating device 1 disclosed in each embodiment can be applied to heat treatment after forming the wire into a helical shape, such as the surface quenching in the processes P13 and P23, tempering in the processes P14 and P24, or the surface softening treatment in the processes P15, P25, and P35. For example, when the surface softening treatment in the processes P15, P25, and P35 is performed on part of the coil spring in the length direction, such as the end turn portion, the first terminal 3A and the second terminal 3B are attached to both end portions of this part.

The heating method using the heating device 1 disclosed in each embodiment may be applied to the heat treatment before forming the wire into the helical shape such as the quenching in the process P31, the tempering in the process P32.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An alternating current heating method, comprising:
preparing a conductive workpiece;
attaching a first terminal and a second terminal connected to a power source, which is capable of supplying alternating current, to the workpiece,
providing a first conductor that is electrically floating at a position that generates proximity effect at time of applying the alternating current to the workpiece, and
heating at least part of the workpiece by applying the alternating current to the workpiece through the first terminal and the second terminal.

2. The alternating current heating method of claim 1, further comprising:
providing a ferromagnetic body near the workpiece.

3. The alternating current heating method of claim 2, wherein
the workpiece, the first conductor, and the ferromagnetic body are provided such that the workpiece is located between the first conductor and the ferromagnetic body.

4. The alternating current heating method of claim 1, further comprising:
providing a second conductor connected to the second terminal and the power source such that the second conductor is electrically insulated from the first conductor, and
at time of heating at least part of the workpiece, the alternating current flows in a circuit in which the first terminal, the workpiece, the second terminal, and the second conductor are included in this order.

5. An alternating current heating device, comprising:
a power source configured to supply alternating current;
a first terminal and a second terminal configured to be connected to the power source and to be attached to a conductive workpiece; and
a first conductor configured to be electrically floating and to be provided at a position that generates proximity effect at time of applying the alternating current to the workpiece, wherein
at least part of the workpiece is heated by applying the alternating current to the workpiece through the first terminal and the second terminal.

6. The alternating current heating device of claim 5, wherein
the first conductor is in a cylindrical shape that includes a first portion and a second portion, which are divided in a circumferential direction,
the first potion includes a first flange portion provided at an end portion in the circumferential direction,
the second potion has a second flange portion provided at an end portion in the circumferential direction, and
the first portion and the second portion become electrically continuous by bringing the first flange portion and the second flange portion in contact.

7. The alternating current heating device of claim 5, wherein
the first conductor is in a cylindrical shape that includes a first portion and a second portion, which are divided in a circumferential direction,
the first portion has a first tapered surface provided at an end portion in the circumferential direction and inclined with respect to a radial direction of the first conductor,
the second portion has a second tapered surface provided at an end portion in the circumferential direction and inclined with respect to the radial direction, and
the first portion and the second portion become electrically continuous by bringing the first tapered surface and the second tapered surface in contact.

8. The alternating current heating device of claim 5, wherein
the first conductor is in a cylindrical shape that includes a first portion and a second portion, which are divided in a circumferential direction, and
the first potion and the second portion are connected to each other by a conductive material having elasticity or flexibility.

9. The alternating current heating device of claim 5, wherein
the first conductor is in a cylindrical shape that includes a first portion and a second portion, which are divided in a circumferential direction,
one of the first portion and the second portion has a recess provided at an end portion in the circumferential direction, and
the other of the first potion and the second portion has a protrusion insertable into the recess.

10. The alternating current heating device of claim 5, wherein
the first conductor is in a cylindrical shape that includes a first portion and a second portion, which are divided in a circumferential direction, and
the first potion and the second portion are connected to each other via conductive liquid.

11. The alternating current heating device of claim 5, wherein
the first conductor is any one of copper, a copper alloy, aluminum, and an aluminum alloy.

12. The alternating current heating device of claim 5, further comprising:
a ferromagnetic body configured to be placed near the workpiece.

13. The alternating current heating device of claim 5, further comprising:
a second conductor configured to be connected to the second terminal and the power source and to be electrically insulated from the first conductor.
